(19) United States
(12) Patent Application Publication
(10) Pub. No.: US 2024/0081347 A1
(43) Pub. Date: Mar. 14, 2024

(54) Food Preparation and Decoration System

(71) Applicant: Sean Adler, Walnut, CA (US)

(72) Inventor: Sean Adler, Walnut, CA (US)

(21) Appl. No.: 18/367,401

(22) Filed: Sep. 12, 2023

Related U.S. Application Data
(60) Provisional application No. 63/406,153, filed on Sep. 13, 2022.

(51) Int. Cl. A21C 9/04; A23P 20/20; G06F 16/583; G06V 10/56; G06V 10/75; G06V 20/68

(52) U.S. Cl. CPC A21C 9/04; A23P 20/20; G06F 16/5838; G06V 10/56; G06V 10/751; G06V 20/68

(57) ABSTRACT

A computer enabled food preparation and decoration system is provided for reproducing customer provided digital images in a food image upon an image reproduction area of food to be produced for the customer. The food image is produced using foodstuffs having foodstuff colors determined to match areas of the digital image where the substantially similar image colors are present.

This application claims priority to U.S. Provisional Patent Application Ser. No. 63/406,153 filed on Sep. 13, 2022, which is incorporated herein in its entirety by this reference thereto.

### BACKGROUND OF THE INVENTION

### 1. Field of the Invention

The invention herein disclosed relates generally to the preparation of food, such as pizza. More particularly, it relates to a system for the positioning and formation of user chosen images on food, such as pizza using software and hardware operating to the task of discerning a customer provided image and choosing the appropriate food or condiments for placement in specific positions on the food to thereby generate the chosen image on the finished food.

### 2. Prior Art

### Background of the Invention

In the United States and throughout many industrialized countries, the preparation of food and meals has moved from a task handled in the home to one where consumers may order a wide variety of different prepared foods and meals from the many different restaurants and food establishments in their community. Such meals, ordered by consumers, may be off a standard menu for the vendor, or in the case of meals such as pizza, the consumer may customize their order based on their likes and dislikes of various condiments and foodstuffs. Further, with the advent of smartphone-dispatched food pick up and delivery, consumers need not even visit the locale preparing their meals as it can be delivered.

Conventionally, meals with more customization for user taste, such as pizza, employs a finite number of add-ons and condiments the consumer can choose to have placed on the underlying pizza dough. Depending on the preparing vendor, the chosen food add-ons and condiments will be placed on the ordered pizza in different fashions as the consumer has no choice in how the order proceeds once it is submitted. This system works well, in general, since conventionally, it is the finished food or pizza that the consumer is interested in, and the appearance of the food on arrival is secondary at best.

With respect to the above, before explaining at least one preferred embodiment of the food preparation and decoration system herein, it is to be understood that the system invention is not limited in its application to the details of employment and to the arrangement of the components or the steps set forth in the following description or illustrated in the drawings. The various components and configurations herein disclosed for the pole engageable support, are capable of other embodiments, and of being practiced and carried out in various ways to yield the ultimate decorated product, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based, may readily be utilized as a basis for other food preparation and decorations systems. It is important, therefore, that the embodiments, objects and claims herein, be regarded as including such equivalent construction and methodology insofar as they do not depart from the spirit and scope of the present invention.

### SUMMARY OF THE INVENTION

The disclosed device and system herein provides for the formation of images upon food being prepared for a customer which includes the formation of a user-chosen or provided photo or other image upon the food being prepared. The system uses a database of individual foodstuffs, such as sauces and individual condiments which are positioned on the food, which correlate to the formation of portions of images when placed thereon.

In operation, the system herein employs software operating to the task of digital image review. Based upon the review of a captured or provided digital image, software operating to the task of discerning colors, shades, and shadows and the like in a digital or provided image then chooses individual foodstuffs such as sauces and dressings and condiments and the like which, when placed on the food being prepared, will form portions of a complete rendition of the digital image chosen or submitted by the buyer.

In the system herein, a foodstuff database is held in electronic memory connected to or accessible to the local food preparation store or site. The foodstuff database operates to correlate a color or shade or the like found discerned in a portion of the digital image to each individual foodstuff held in the foodstuff database which correlates to the discerned color or shade of the digital image. For example only, where a digital color image being reviewed by the system is discerned to have the color red in portions of the digital image, foodstuffs correlating to red which are available to the local food preparer, such as a restaurant, are identified. The positioning in the digital images is also identified such that when a rendition of a digital image submitted by a customer or buyer is to be generated on the ordered food, such as pizza, the system will choose the foodstuff correlating to each discerned color and shade in the digital image and position each individual foodstuff upon the food being prepared in the proper location thereon to provide the portion of color and shades of the image being depicted. This same process is used for each color and shade and halftone of a digital or digitized image.

Once the system has reviewed the digital image and identified the exact individual foodstuffs to be placed on the prepared food correlating to the discerned color or shading, in the identified appropriate locations, the formation of the chosen image on the food, such as a pizza, occurs. In this step, using a liquid dispensing device similar to an inkjet printer and a solid foodstuff retrieval and placement device, the system will place liquid and solid foodstuffs in the determined respective locations upon the food being prepared to form a rendition of the digital image chosen or provided for such by the buyer.

The liquid dispersing component will have dispensing nozzles thereon which are supplied with liquid foodstuff, such as sauces and melted or liquified food, such as cheese and other sprayable food stuffs to generate all or a portion of the chosen image. As noted, the liquids are chosen from those known to be locally available which correlate in the database to the colors in the chosen reviewed digital image. This liquid portion is, thus, applied to the food being prepared in the proper locations to form a part of the image by actuation of the appropriate spray nozzle which will dispense the chosen foodstuff therefrom having the correlating color and position to that of the chosen image. A supply of each liquid foodstuff is connected to jets which will spray the appropriate liquid in determined positions which match the locations determined in the digital image for that color.

For portions of the user chosen image to be depicted on the food being prepared which are not liquid, the system may employ food retrieving and depositing components, such as suction components, to pick up the foodstuff correlating in the database to the color in the digital image. Using the suction or other retrieving or food grasping components, the solid food chosen to depict a color or tone in an identified area of the digital image being reproduced, will be picked up from a reservoir or container of such foodstuff and then deposited in the appropriate position on the food being prepared to form the color of the digital image in that position. Robotic foodstuff components, using suction or mechanical grasping or the like to make customized food for customers, are widely available in the food preparation industry, for example those sold by Nala Robotics of Arlington Heights, Illinois.

For each portion of an image being reproduced from a digital image and formed on a food being prepared, such as the planar top of a pizza, the system herein will cause the positioning of one or both of a sauce or dressing or the like and/or a food stuff, which respectively correlates in the database to the color or tone or half tone discerned from the digital image.

During preparation of the food for the customer, in order to have the food-depicted version of digital images for multiple clients, can also include a drive belt or platter or the like, which will move the food being prepared under an overhead spray nozzle system for deposit of liquid food and an overhead pickup and depositing system for solid food.

As the belt moves with food being prepared thereon, such as, for example, pizza, the colored food deposit can employ the suction or mechanical food grabbers to removably grasp the appropriate food for the determined color and position the chosen food of the appropriate color in the determined appropriate spot for that color or portion of the image on the food. The belt will be timed or have movements which position the food under the solid food positioners to help locate the placed food properly. Spray or other liquid dispensers will operate to properly place colored liquid food product in the proper positions to render the liquid portions of the chosen image on the food in combination with the movement of the belt. Further, there can be combinations of such and in addition, the food itself can be moved on a belt or table during the positioning.

As an example only and in no way limiting, for a buyer chosen or provided digital image having red, white, and black, the system may deposit liquid using jets for the red as tomato sauce and the white as liquified cheese. The black may correlate to black olives, which will be picked up by the retrieving and depositing component, such as a suction actuated component which will induce suction to hold the olives in a temporary position and terminate the suction when the olives are located over the area of the food being prepared, which correlates to the black area in the digital image which has been previously mapped.

Using the example which should not be considered limiting, such as pizza, the pizza dough in a planar positioning can be placed on a moving belt or platter. The belt or platter will move underneath the liquid food spray nozzles and the solid food positioners. Using a camera or the like to continuously determine the position of the pizza dough during the process, both the movement and the timing of liquid and solid food deposits and the belt, can be calculated and controlled to thereby cause the formation of the depiction of the digital image upon the food being prepared. Additionally, the carriage holding one or both of the mechanical food depositing components and the liquid food depositing components can be operatively suspended over the food, such as a pizza and move while forming the image, or move in combination with a belt or table moving to form the image on the food.

The system will work especially well in the preparation of food having a substantially planar top surface, such as pizza or, for example, a cake. Software, operating to the task of matching colors and tones and the like to known liquid and known solid foodstuffs locally available, will decide which liquid and/or solid foodstuff to place in every position to render the digital image to be reproduced on the food. Thereafter, using the spray nozzles and solid food positioning components overhead, movement of the dough or cake through the controlled movement of the belt or platter on which they sit will allow the nozzles and solid food positioners to form the chosen or provided digital image upon the food positioned on the belt or platter. Such a belt can be a moving conveyer type belt or a platter which can be moved on cables or the like in different directions necessary.

In all modes of the system and steps, herein noted, the system provider will employ network accessible servers or computers having accessible electronic memory for storage and retrieval of electronic database information relating to the foodstuffs and the respective color or tone of each and related data needed to correlate the colors of a digital image to the liquid and solid foodstuffs employable to render portions of the digital image to a food image. Software running in electronic memory will operate to perform each step or task or calculation herein based on the provided or scanned digital image and ascertained colors and tones therein determined to match colors and tones of liquid and solid foodstuffs. Thereafter, using the color and tone matched foodstuffs, such will be positioned robotically upon the food to form the food image of the digital image.

As to electronic memory or computer readable media for the system herein, any combination of one or more computer-usable or computer-readable media, be it transitory or non transitory, may be employed for operation of the software and assessment system herein. Such, for example and in no way limiting, can include computer-readable media and may include one or more of a portable computer diskette, a hard disk, a random access memory device, a read-only memory device, an erasable programmable read-only memory (EPROM or Flash memory) device, a portable compact disc read-only memory device, an optical storage device, and other electronic memory magnetic storage devices. Software or computer program code for carrying out the individual and sequential operations and airflow assessments of the present invention may be written in any combination of one or more programming languages.

The steps or method of operation and/or execution of the various modes and tasks of the system herein may be illustrated as blocks or steps in the drawings which may represent one or more sequences in the operation of the steps and assessments in the system herein. These operations or steps can be implemented in hardware, software operating to process input or ascertain data to then accomplish the task or step, or a combination thereof.

With regard to software operating to a task or steps or image assessments indicated in the system herein, such represents computer-executable instructions stored upon one or more transitory or non-transitory computer-readable storage media, which, when executed by one or a plurality of processors, will operate to perform the recited task, assessment, operation or step. Computer-executable instructions, in general, include routines, programs, algorithms, data structures, and the like which are configured to perform particular functions or to implement particular abstract data types or steps noted.

It should be noted that the sequence in which the steps of the system herein are described or depicted for discerning colors and tones within a submitted digital image and ascertaining individual foodstuffs to form a food image thereof, are not intended to be construed as a limitation. It should be understood that any number of the described or designated steps can be combined in any order and/or in parallel to implement the described and depicted assessments and processes. In some modes of the system herein, one or more steps can be rearranged or omitted entirely. Still further, the software-enabled steps in the system herein can be combined in whole or in part with each other or with other steps or methods.

With respect to the above description, before explaining at least one preferred embodiment of the food preparation and decoration system herein, it is to be understood that the invention is not limited in its application to the details of operation nor the arrangement of the components or the steps set forth in the following description or illustrations in the drawings. The various methods of implementation and operation of the system herein in the preparation of food, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other devices and systems for carrying out the several purposes of the food preparations and decoration system herein. Therefore, that the objects and claims herein should be regarded as including such equivalent construction, steps, and methodology insofar as they do not depart from the spirit and scope of the present invention.

It is an object of this invention to provide a system for the customization of placement of foodstuffs and condiments atop food being prepared to form a depiction of a provided digital image, photo, or drawing or the like submitted by a buyer.

It is a further object of this invention to provide such a photo or drawing depiction system for food which provides for positioning of food, sauces, and condiments to form the image on the pizza where shadows and image lines are provided by the placement of food which is computer chosen to provide such a depiction.

It is a further object of the invention to provide such an image generating and positioning system for prepared food, such as pizza, wherein the taste choices of the buyer as to used foodstuffs are included to substitute condiments and foodstuff disliked by the buyer with substitutes.

These together with other objects and advantages, which become subsequently apparent reside in the details of the construction and operation of the food image generating system herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, by the term “substantially” with regard to size or volume or mass, is meant plus or minus five percent, unless respectively otherwise defined, and by the term “substantially” with regard to alignment and positioning is meant plus or minus five percent.

### BRIEF DESCRIPTION OF DRAWING FIGURE

FIG. 1 shows a flow chart of the system herein to generate images on food using foodstuffs having correlating colors to those of a digital image.

FIG. 2 depicts a graphic depiction showing a simplified configuration of components of the system herein for positioning foodstuffs on food being prepared to form an image thereon substantially similar to a digital image from a customer.

FIG. 3 shows an image scanner located on the preparation line after the positioning of the foodstuffs thereon wherein the reproduced image on the food is compared with the chosen image from the customer.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer components or portions of the system as it they may be oriented or appear in the drawings and are used for convenience only. Any such terms are not intended to be limiting or to imply that the device has to be used or positioned in any particular orientation.

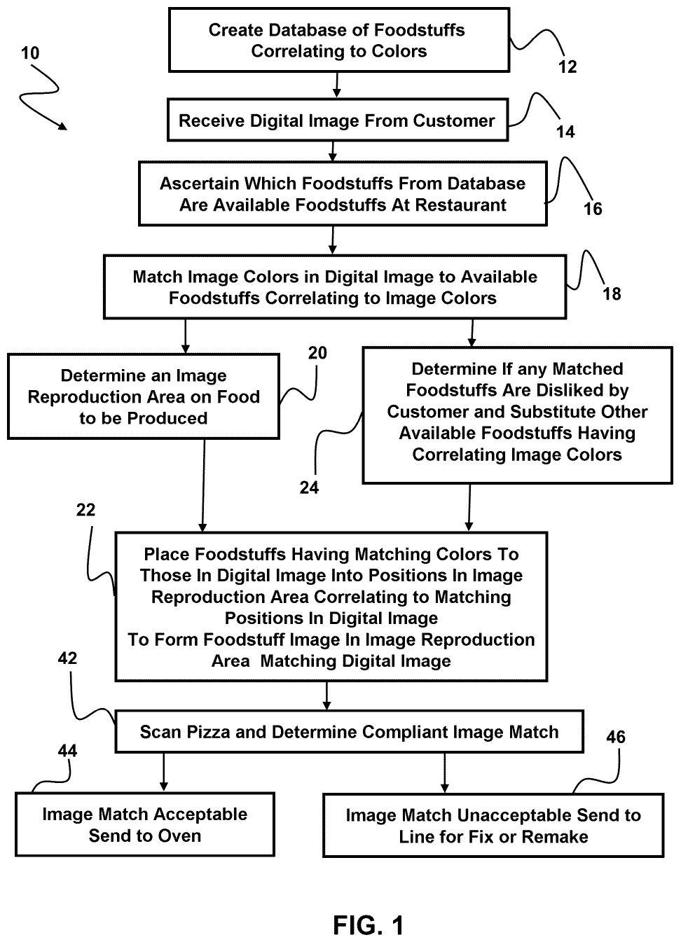

Referring now to FIG. 1-3, the food preparation system 10 herein for imparting an image on to food from a digital image from a customer, there is seen in FIG. 1 a simplified flow chart of the system 10 herein. As shown, the simplified chart depicts steps to generate images on food using foodstuffs determined to have correlating colors, shades, and the like to those of a digital image.

In a first step, a relational database is created and held in electronic memory accessible to the software operating to each of the noted tasks herein. The database of foodstuffs 12 correlates the known foodstuff color and shade of the image colors and shades which may appear in different areas of a digital color image. For example only, oregano is dark green and mozzarella cheese is off white. By foodstuffs herein is meant any edible food or spice or liquid or the like, which has a color which can be determined and saved to a database and correlated to such colors for foodstuffs used in portions of a digital image.

The determined color of any such individual foodstuff will preferably be stored in electronic memory as a digitally identified foodstuff color identifier. By color identifier is meant using a CMYK or RGB color designation or, more preferably, such as by using a standardized industry color designation, such as the Pantone Color System, to give each individual foodstuff a color identifier. In this fashion, each respective liquid or solid foodstuff in the database will correlate to a color identifier in a standardized fashion.

The digital image can then be examined by software operating to the task of determining individual portions thereof which correlate to individual color identifiers and match those portions to the same color identifier associated with each individual foodstuff.

Once the database 12 is created and each foodstuff held therein is categorized with a standardized color code or color identifier, a digital image received from a customer 14 may be examined by software operating to the task. During the examination of the chosen digital image, portions of a provided digital image will be assigned the same standardized color designations for specific areas and pixels in the digital image determined to be substantially such a color or tone by software operating to that task. Where the digital image is electronically provided, such can be handled within electronic memory by the image examining software. Where a physical image, such as a photograph, is provided by the customer, a scanner will first form a digital image from the physical image.

With the colors of pixels and areas within the digital image so identified, using the same color identifiers as employed in the database 12, software operating to the task of matching the color identifiers within areas and pixels of the digital image, will match them 18 to the foodstuffs in the database 12 having the same or similar color identifiers. This step will identify the specific foodstuffs available to the store or food provided to employ to recreate the digital image on the food.

In another step, an image reproduction area will be determined on the surface of the food 20. Where the size and shape of the food, such as a small pizza, is standardized, the reproduction area can be all or a determined portion of the food surface. Thus, the reproduction area may be the same space every time on a particular sized food, such as a pizza. Alternatively, the reproduction area can be changed or moved and tracked on the food surface, such as by using a video camera to track the movement of the food surface past the components depositing the foodstuffs in the correct positions within the reproduction area to form the image.

Once the reproduction area is determined 22 and the foodstuffs for positioning therein with the correct colors are matched 18, the system employing components configured to spray liquid foodstuffs and to deposit solid foodstuffs within the reproduction area will form the digital image within the reproduction area 22. As noted above, spray nozzles having a pressurized supply of each liquid foodstuff can be employed for deposit thereof on the food being prepared. As also noted, robotic suction or mechanical grasping components are employed to removably grab portions of solid foodstuffs correlating to colors and tones on positions in the image and deposit such in the matching positions on the food for the food image.

In an alternative but preferred step for both the palate and health of customers, they may input a listing of foodstuffs they dislike or to which they have an allergy or would rather not use. Software operating to the task of choosing substitute foodstuffs will operate to determine 24 substitutes before such are placed in the correct positions within the reproduction area.

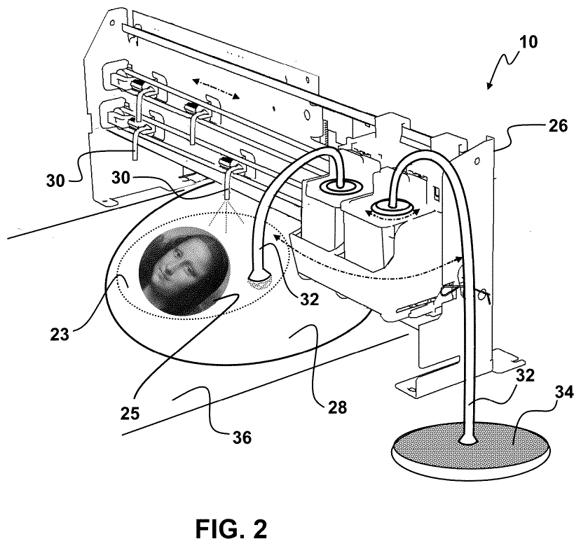

Operation of the system 10 herein locally at venues, such as restaurants, can be enabled using a foodstuff positioner 26, as shown for example in FIG. 2. As shown, the positioner 26 is located to a position preferably above the food 28 on which the reproduction of the digital image is to be generated within the reproduction area 23. In some modes of the system, the positioner 26 may employ spray nozzles 30 for positioning fluid type or fluid foodstuffs upon the appropriate portions of the reproduction area 23. For example, tomato sauce or heated cheese can be dispensed from the nozzles 30 to the areas of the reproduction area 23 requiring the color of the foodstuff from one of the nozzles 30. While shown as four spray nozzles 30, such should not be limiting as there can be an infinite number of spray nozzles 30 which can be mounted on the foodstuff positioners 26 configured for such.

Also shown on the positioner are the non-fluid foodstuffs depositing components 32. Such are configured to be able to pick up a portion of a non-fluid foodstuff and deposit such in the correct position within the reproduction area 23 on the food 28 identified for the solid food to reproduce. As shown, the depositing components 32 are formed of a tubular member which can both be rotated and moved vertically and horizontally. Such allows the depositing components 32 to pick up the non-fluid food 34 from a container of such and to deposit it onto the reproduction area 23 in the correct position for the non-fluid foodstuff to provide the color and/or shading to the image being produced in the reproduction area 23, which is based on the digital image from the customer.

Of course other types of depositing components 32 as would occur to those skilled in the art are anticipated as within the scope of this patent such as mechanically activated arms and the like with grippers or the like at the distal end to grasp and drop the chosen non-fluid food stuff.

In all modes of the system 10 herein, either the positioner 26 will move in multiple directions while over the reproduction area 23, or the food support 36, such as a belt or table, will be configured to move in multiple directions over the reproduction area, or both may move. This allows software operating to position the foodstuffs in the reproduction area 23 in the correct positions to render the colors and shades to the image 25 produced from the various foodstuffs chosen to do so.

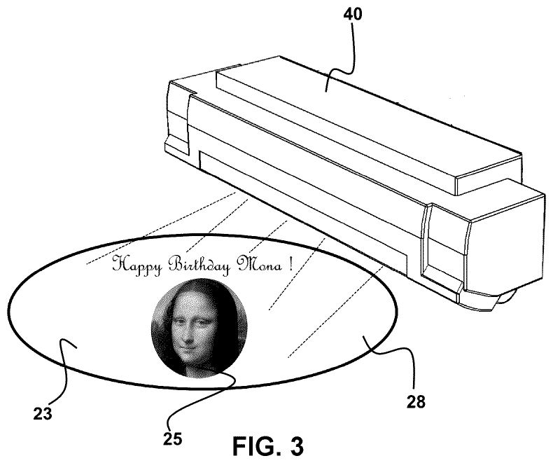

In a final but preferred step, to insure quality as well as prevent accidental non conforming images 25 on the food being produced, FIG. 3 shows an image scanner 40 located on the food preparation line in a location after the positioning of the foodstuffs thereon. The scanner 40 will scan the reproduced image 25 on the food 28 and communicate a scanned digital image to the computer or server running the software operating the system. In an inspection step 42, software operating to the task of comparing the reproduced image 25 on the food 28 to the original digital image will determine if the reproduced image 25 is substantially similar to the original digital image.

Where it is determined the reproduced image 25 is an acceptable match 44 to that of the original image, the food will either be sent for cooking or where finished without cooking, sent to the customer. Where it is determined the reproduced image 25 is unacceptable 46, the food 28 will be sent for remake and not sent to the customer at that point in time.

While all of the fundamental characteristics and features of the food preparation and decoration system herein have been shown and described, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art, without departing from the spirit or scope of the invention. Consequently, all such modifications and variations and substitutions are included within the scope of the invention as defined by the following claims.

What is claimed is:

1. A computer enabled food preparation and decoration system for positioning an image upon food, comprising the steps of:
creating a foodstuff database of individual respective edible foodstuffs where each respective edible foodstuff has a foodstuff color;
using a digital image from a customer and matching image colors in portions of said digital image, to a respective individual foodstuff color; and
on a determined image reproduction area of food to be produced, forming a food image of said digital image by placing individual respective foodstuffs having a respective foodstuff color onto respective positions in said reproduction area correlating to image colors of said digital image, whereby a rendition of said digital image is positioned upon said image reproduction area.

2. The computer enabled food preparation and decoration system for positioning an image upon food of claim 1, additionally comprising:
determining if any of said foodstuffs in said foodstuff database are disliked by said customer; and
employing alternate said individual foodstuffs from said database of individual respective foodstuffs from those determined to be disliked by said customer for forming said food image.

3. The computer enabled food preparation and decoration system for positioning an image upon food of claim 1, additionally comprising:
scanning said food with an image scanner subsequent to said forming of said food image and capturing a scanned food image within said image reproduction area;
if said scanned food image is determined to be a match to said digital image, allowing said food to cook or be delivered to customer; and
if said scanned food image is determined not to match said digital image, sending said food back for fixing or remaking.

4. The computer enabled food preparation and decoration system for positioning an image upon food of claim 2, additionally comprising:
scanning said food subsequent to said forming of said food image and capturing a scanned food image within said image reproduction area;
if said scanned food image is determined to be a match to said digital image, allowing said food to cook or be delivered to customer; and
if said scanned food image is determined not to match said digital image, sending said food back for fixing or remaking.

5. The computer enabled food preparation and decoration system for positioning an image upon food of claim 1, additionally comprising:
creating said foodstuff database of individual respective edible foodstuffs where each respective edible foodstuff has a foodstuff color identifier; and
using said digital image from a customer and matching said image colors in portions of said digital image, to a respective color identifier of an individual foodstuff color.

6. The computer enabled food preparation and decoration system for positioning an image upon food of claim 2, additionally comprising:
creating said foodstuff database of individual respective edible foodstuffs where each respective edible foodstuff has a foodstuff color identifier; and
using said digital image from a customer and matching said image colors in portions of said digital image, to a respective color identifier of an individual foodstuff color.

7. The computer enabled food preparation and decoration system for positioning an image upon food of claim 3, additionally comprising:
creating said foodstuff database of individual respective edible foodstuffs where each respective edible foodstuff has a foodstuff color identifier; and
using said digital image from a customer and matching said image colors in portions of said digital image, to a respective color identifier of an individual foodstuff color.

8. The computer enabled food preparation and decoration system for positioning an image upon food of claim 4, additionally comprising:
creating said foodstuff database of individual respective edible foodstuffs where each respective edible foodstuff has a foodstuff color identifier; and
using said digital image from a customer and matching said image colors in portions of said digital image, to a respective color identifier of an individual foodstuff color.
